(19) United States
(12) Patent Application Publication
(10) Pub. No.: US 2025/0210898 A1
(43) Pub. Date: Jun. 26, 2025

(54) CLAMPING UNIT FOR ELECTRICALLY CONTACTING A PLURALITY OF ELECTRIC CONTACTS WITH A PLURALITY OF ELECTRIC CONDUCTORS

(71) Applicant: Phoenix Contact GMBH & Co. KG, Blomberg (DE)

(72) Inventors: Dat-Minh Trinh, Barntrup (DE); Elmar Schaper, Luegde (DE); Helge Blome, Luegde (DE)

(21) Appl. No.: 18/852,164

(22) PCT Filed: Mar. 28, 2023
(86) PCT No.: PCT/EP2023/057897

§ 371 Date: Sep. 27, 2024

(30) Foreign Application Priority Data
Mar. 31, 2022 (DE) 10 2022 107 755.1

(51) Int. Cl. H01R 13/10; H01R 12/70

(52) U.S. Cl. CPC H01R 13/10; H01R 12/70

(57) ABSTRACT

A clamping unit electrically contacts electric contacts with electric conductors and may include electrically conductive clamping elements, each of which has a contact element for electrically connecting to one of the electric contacts and a connection terminal for contacting one of the electric conductors. The contact elements are arranged on the lower face of the clamping unit, and the connection terminals are arranged in receiving chambers for receiving the electric conductors. The longitudinal axis of the contact element is axially offset relative to the central longitudinal axis of the receiving chamber in which the corresponding connection terminal is arranged for multiple clamping elements. The longitudinal axis of each contact element has a greater distance to the edge than the central longitudinal axis of the corresponding receiving chamber in which the corresponding connection terminal is arranged.

A clean version of the Abstract with no markings may be found on the last page of this paper, following the signature page.

### FIELD

The present invention relates to a terminal unit for electrical contacting of a plurality of electrical contacts, in particular electrical contact holes or contact locations of a printed circuit board, with a plurality of electrical conductors, with a plurality of electrically conductive terminal elements, each of which has a contact element, in particular as a contact pin, for electrical connection to one of the electrical contacts and a terminal for contacting one of the electrical conductors, wherein the terminal elements are arranged in such a way that the contact elements are arranged on an underside of the terminal unit, the connection terminals are arranged in receiving chambers for receiving the electrical conductors, wherein the receiving chambers each have an insertion orifice towards an upper side of the terminal unit for inserting the electrical conductors.

The present invention additionally relates to a unit comprising a printed circuit board which has a plurality of electrical contacts, which are designed in particular as electrical contact holes or contact points, and a terminal unit which is connected to the electrical contacts of the printed circuit board for making contact with a plurality of electrical conductors.

The present invention also relates to a contacting set with a plurality of different terminal units for electrically contacting a plurality of electrical contacts with a plurality of electrical conductors, wherein the electrical contacts are in particular electrical contact holes or contact points of a printed circuit board (PCB).

The present invention also relates to a printed circuit board contacting set comprising a printed circuit board having a plurality of electrical contacts, which are designed in particular as electrical contact holes or contact points, and a plurality of different terminal units for electrically contacting the electrical contacts of the printed circuit board with a plurality of electrical conductors.

Various terminals are known from the state of the art, for example so-called PCB terminals, for connecting electrical conductors to printed circuit boards. The PCB terminals have contact elements in the form of contact pins, which are usually inserted into contact holes in the PCB and soldered there. For connection to the electrical conductors, the PCB terminal blocks include connection terminals for contacting the electrical conductors. The contact pins are attached to an underside of the terminal, and the connection terminals are arranged in receiving chambers for receiving the electrical conductors, whereby the receiving chambers each have an insertion orifice on an upper side of the terminal unit for inserting the electrical conductors. This results in overall contacting in an axial direction. The contact elements and connection terminals are typically designed in one piece.

Today, such PCB terminal blocks have to fulfill a variety of tasks and requirements. For example, space may be required on the top of the terminal for connecting electrical conductors with the largest possible cross-section, so that correspondingly large conductor connection openings are required for inserting the electrical conductors into the terminals, as well as space for guiding the electrical conductors to the terminal. If ferrules are used for the electrical conductors, additional space is required as the ferrules have a larger cross-section than the corresponding electrical conductors. In addition, access to the terminal is required in order to insert the electrical conductors into the conductor connection openings and to operate the terminal in order to clamp the electrical conductors in the connection terminals and/or to release the clamping of the electrical conductors in the connection terminals. For space reasons, it may be necessary to position the contact elements as compactly as possible. Particularly on printed circuit boards, space is finite and must therefore be used sparingly. On the other hand, there are requirements for distances between electrical contacts, especially on printed circuit boards, for example to maintain sufficient clearance and/or creepage distances. In addition, there may be restrictions on the arrangement of the electrical contacts. For example, regular spacing of the electrical contacts may be specified on printed circuit boards, which must be brought into line with the other requirements.

In the state of the art, universal terminals are known that can only solve these diverse tasks and requirements to a limited extent. This often unnecessarily increases the space required on printed circuit boards and makes it unnecessarily difficult to attach the terminals and connect electrical conductors.

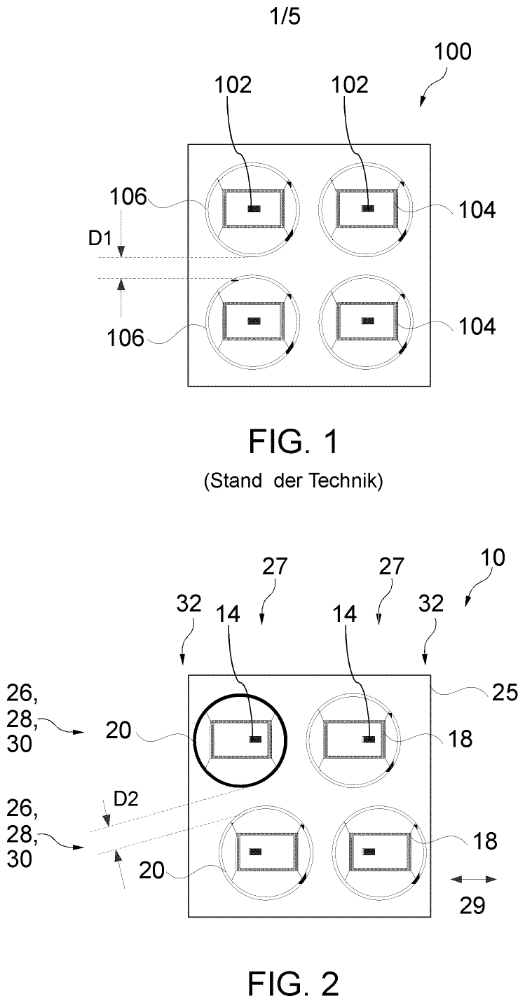

One such terminal 100 from the prior art is shown in a top view in FIG. 1, by way of example. The terminal 100 is designed as a PCB terminal for making electrical contact with a plurality of electrical contact holes of a printed circuit board with a plurality of electrical conductors. The terminal 100 comprises a plurality of contact elements 102, which are designed here as contact pins, for electrical connection to the electrical contacts. The contact elements 102 extend on an underside of the terminal unit 100. A connection terminal, not explicitly shown in FIG. 1, for contacting the electrical conductors is accommodated in receiving chambers 104. The receiving chambers 104 each have an insertion orifice 106 towards an upper side of the terminal unit 100 for inserting the electrical conductors and are open towards an upper side of the terminal unit 100. A longitudinal axis of the contact element 102 is arranged in accordance with a central longitudinal axis of the receiving chamber 104, in which the respective connection terminal is arranged. There is a distance D1 between the insertion openings 106. The same considerations apply to distances between the receiving chambers 104.

Overall, there are high requirements for the design of PCBs when using terminal blocks, especially PCB terminal blocks. This is associated with great effort and high costs. In some cases, it may be necessary to use larger PCBs merely to be able to attach the terminals accordingly. This can lead to further problems.

The present invention is thus based on the task of improving and/or simplifying the electrical contacting of a plurality of electrical contacts, in particular electrical contact holes or contact points of a printed circuit board, with a plurality of electrical conductors. The task also consists in eliminating or at least mitigating at least some of the disadvantages or problems described in the prior art.

The problem underlying the present invention is solved by a terminal unit with the features of claim 1. Advantageous embodiments of the terminal unit are described in claims 2 to 10, which are dependent on claim 1.

In more detail, the task underlying the present invention is solved by a terminal unit for electrically contacting a plurality of electrical contacts, in particular electrical contact holes or contact points of a printed circuit board, with a plurality of electrical conductors, with a plurality of electrically conductive terminal elements, each of which comprises a contact element, in particular as a contact pin, for electrical connection to one of the electrical contacts and a connection terminal for contacting one of the electrical conductors, the terminal units being arranged in such a way that the contact elements are arranged on an underside of the terminal unit, for electrical connection to one of the electrical contacts and a connecting terminal for contacting one of the electrical conductors, wherein the terminal elements are arranged such that the contact elements are arranged on an underside of the terminal unit, the connecting terminals are arranged in receiving chambers for receiving the electrical conductors, and wherein the receiving chambers each have an insertion orifice towards an upper side of the terminal unit for inserting the electrical conductors.

The terminal unit according to the invention is characterized in that for several of the terminal elements, preferably for all terminal elements, a longitudinal axis of the contact element is arranged axially offset to a central longitudinal axis of the receiving chamber in which the corresponding terminal is arranged, and at opposite edges of the terminal unit the terminal elements closest to the respective edge are arranged in such a way that the longitudinal axis of the respective contact element exhibits a greater distance to the edge than the central longitudinal axis of the corresponding receiving chamber in which the corresponding terminal is arranged.

The basic idea of the present invention is to decouple the positions of the contact elements and the receiving chambers, in which the connection terminals are accommodated, from the positioning of the contact elements and the receiving chambers, in which a longitudinal axis of the contact element is arranged in accordance with a central longitudinal axis of the receiving chamber in which the respective connection terminal is arranged, as is customary in the prior art. The arrangement of the terminal elements closest to the respective edge according to the invention has the effect that the respective contact elements have a large distance to the corresponding edge, for example to provide sufficient clearance or creepage distances to neighboring printed circuit boards or generally to neighboring electrical components. The distance from the edge is ensured for the contact elements even if the associated receiving chambers are positioned close to the edge.

The opposite edges of the clamping unit relate to two opposite edges. Accordingly, the invention can in principle also be realized for several opposite edges in pairs. The terminal elements closest to the respective edge result in particular from a distance of the central longitudinal axis of the receiving chambers, in which the corresponding terminal units are arranged, from the edge. With several terminal elements located close to the edge, a greater overall distance of the contact elements from the respective edge is maintained.

If there are several terminal elements closest to the respective edge, all these terminal elements are arranged in such a way that the longitudinal axis of the respective contact element is at a greater distance from the edge than the central longitudinal axis of the corresponding receiving chamber in which the corresponding terminal unit is arranged. Otherwise only one. This applies to both opposite edges.

The terminal unit according to the invention can thus overcome various of the disadvantages mentioned above. The advantages also arise for the printed circuit board or a unit comprising the printed circuit board and the terminal unit connected to it when connected to the electrical contacts of the printed circuit board.

Furthermore, different types of terminal units can be provided which, depending on the arrangements and orientations of the terminal elements closest to the edge, as well as the arrangements and orientations of further terminal elements, have different advantages and can eliminate various disadvantages of the prior art.

For example, terminal units can be provided in which electrical conductors with larger conductor cross-sections are used without increasing the dimensions of the terminal units, or terminal units can be provided which have a smaller size when using electrical conductors with the same conductor cross-sections. Advantages can thus be achieved, for example, with regard to a system voltage, a terminal compartment size for connecting the electrical conductors and a conductor cross-section.

In principle, the terminal unit can contact any number of electrical contacts and electrical conductors. Small terminal units can be realized with two or four terminal elements for contacting a corresponding number of electrical contacts and electrical conductors. There are no fundamental restrictions on the number of terminal elements.

The terminal elements are typically made of an electrically conductive material so that there is an automatic electrical connection between the contact elements and the connection terminals. The terminal elements usually have an overall elongated shape, which is formed by the contact elements and the connection terminals. Accordingly, the terminal unit is designed for contacting in the longitudinal direction.

The connection terminals are positioned in the receiving chamber to contact electrical conductors inserted therein.

The contact elements often have an elongated shape, for example in the form of a contact pin, which makes it easy to determine the longitudinal axis of the contact element. However, the contact element can also have other shapes, for example for SMD technology, the contact elements can be designed with a nail head for contacting the electrical contacts. The longitudinal axis of the contact element is defined by the center of its cross-section. The longitudinal axis would then be, for example, an axis of symmetry in the center of the nail.

The contact elements can be designed as solder pins for soldering to the printed circuit board, in particular for soldering in a state inserted into the contact holes. Alternatively, the contact elements can be designed for clamp mounting in the contact holes, for example in the form of clamp contacts or so-called press-fit pins.

The receiving chambers can have different cross-sections, for example a round, oval, rectangular or square cross-section. Rectangular or square cross-sections are preferred here. The receiving chambers relate to chambers into each of which an electrical conductor can be inserted. This means that the connection terminals are positioned in the receiving chambers and can contact the electrical conductors within the receiving chambers.

The electrical contact holes are commonly found on conventional PCBs. In SMD technology, contact points or contact pads are arranged on the circuit board.

The contact elements can protrude from the underside of the terminal unit for contacting the electrical contacts.

The electrical conductors typically have an electrically conductive core and surrounding insulation. The electrical conductors are therefore typically stripped at the ends that are inserted into the receiving chambers. In addition, wire end sleeves can be slipped over the ends of the electrical conductors and clamped or crimped onto them.

In an advantageous embodiment of the invention, the connection terminals each have a bottom region at their ends opposite the insertion orifices, and the contact elements are attached to the bottom region of the connection terminals and extend in the longitudinal direction thereof. This design can be realized for all terminal elements, i.e. for terminal elements in which the longitudinal axis of the contact element is axially offset from a central longitudinal axis of the receiving chamber in which the corresponding connection terminal is arranged, as well as for conventional terminal elements in which the longitudinal axis of the contact element and a central longitudinal axis of the receiving chamber in which the corresponding connection terminal is arranged coincide. The contact elements can be produced simply as stamped and bent parts, for example.

In an advantageous embodiment of the invention, the connection terminals are designed as spring-loaded terminals with a clamping spring, which hold the inserted electrical conductors in a clamping manner with their spring force, with the terminal unit preferably having actuating elements in order to release the clamping of the electrical conductors by the clamping springs when actuated.

Alternatively, the connection terminals are designed as screw terminals and the terminal unit has actuating screws with which the electrical conductors are clamped and released in the connection terminals. Corresponding spring-loaded terminals and screw terminals are known as such and are suitable for use in the terminal unit. The actuating elements of the spring-loaded terminal can be designed as actuating pushers or actuating pushers. As an alternative to the actuating elements, the terminal unit can have actuating openings. The clamping springs can be actuated with an external actuating tool, such as a screwdriver, through the actuating opening.

In an advantageous embodiment of the invention, the contact elements on the underside of the terminal unit extend in several contact element rows, wherein the contact elements in each contact element row preferably are evenly spaced apart, and/or the contact elements on the underside of the terminal unit extend in several contact element columns, wherein the contact elements in each contact element column preferably are evenly spaced apart. This design of the terminal unit enables a simple and regular configuration of the printed circuit board with the electrical contacts, for example. The advantages according to the invention can be easily realized by the corresponding design of the terminal elements, in which the longitudinal axis of the contact element is axially offset to the central longitudinal axis of the receiving chamber in which the corresponding connection terminal is arranged. In at least one contact element row and/or contact element column, the contact elements can be arranged with uniform spacing. Alternatively, the contact elements can be arranged in a fixed spacing scheme in each contact element row and/or contact element column. The spacing scheme can be individual for each contact element row and/or contact element column. The contact elements in each contact element row and/or contact element column can, for example, be arranged in groups, with the contact elements in each group having the same spacing. Distances from a group of contact elements to a neighboring group of contact elements or to an individual, neighboring contact element can be selected to be different.

In an advantageous embodiment of the invention, the receiving chambers are arranged in a plurality of receiving chamber rows, preferably with the receiving chambers in each receiving chamber row being evenly spaced apart, and/or the receiving chambers are arranged in a plurality of receiving chamber columns, preferably with the receiving chambers in each receiving chamber column being evenly spaced apart. This design of the clamping unit results in a regular arrangement of the receiving chambers, which makes handling easier. The corresponding design of the terminal elements, in which the longitudinal axis of the contact element is axially offset from the central longitudinal axis of the receiving chamber in which the corresponding connection terminal is arranged, means that the advantages of the invention can be readily realized. In at least one receiving chamber row and/or receiving chamber column, the receiving chambers can be arranged with an overall uniform spacing. Alternatively, the receiving chambers can be arranged in a fixed spacing scheme in each receiving chamber row and/or receiving chamber column. The spacing scheme can be individual for each receiving chamber row and/or receiving chamber column. The receiving chambers in each receiving chamber row and/or receiving chamber column can, for example, be arranged in groups, with the receiving chambers of each group having the same spacing. Distances from one group of receiving chambers to a neighboring group of receiving chambers or to an individual, neighboring receiving chamber can be selected to be different.

In an advantageous embodiment of the invention, the contact element rows and the receiving chamber rows are arranged offset in parallel with respect to their longitudinal extent, and/or the contact element rows and the receiving chamber rows are arranged offset in the direction of their longitudinal extent, and/or the contact element columns and the receiving chamber columns are arranged offset in parallel with respect to their longitudinal extent, and/or the contact element columns and the receiving chamber columns are arranged offset in the direction of their longitudinal extent. The staggered arrangement of the contact elements and receiving chambers in staggered rows and/or columns enables, for example, the simple provision of terminal units in which simple and reliable contacting can be made for a plurality of electrical contacts and electrical conductors. The distance between the longitudinal axes of the contact elements and the central longitudinal axes of the receiving chambers can be increased or decreased, depending on the direction of offset. Particularly preferably, adjacent contact element rows or receiving chamber rows and/or contact element columns or receiving chamber columns are arranged offset. This allows distances between the contacts or receiving chambers to be easily adjusted and, for example, increased or maximized.

In an advantageous embodiment of the invention, the terminal elements are arranged in a plurality of terminal element rows, wherein preferably the terminal elements in each terminal element row are uniformly spaced and/or the terminal elements in each terminal element row are uniformly aligned, and/or the terminal elements are arranged in a plurality of terminal element columns, wherein preferably the terminal elements in each terminal element column are uniformly spaced and/or the terminal elements in each terminal element column are uniformly aligned. Due to the corresponding design of the terminal elements, in which the longitudinal axis of the contact element is arranged axially offset to the central longitudinal axis of the receiving chamber in which the corresponding connection terminal is arranged, the advantages according to the invention can also be realized without further effort by positioning, in particular also by regular positioning, of the terminal elements in rows and/or columns. In at least one terminal element row and/or terminal element column, the terminal elements can be arranged with uniform spacing. Alternatively, the terminal elements can be arranged in a fixed spacing scheme in each terminal element row and/or terminal element column. The spacing scheme can be individual for each clamping element column and/or clamping element row. The terminal elements in each terminal element row and/or terminal element column can, for example, be arranged in groups, with the terminal elements in each group having the same spacing. Distances from one group of terminal elements to a neighboring group of terminal elements or to an individual, neighboring terminal element can be selected to be different. By arranging the terminal elements on the opposite edges of the terminal unit, it is possible to ensure that the terminal elements closest to the respective edge are arranged in such a way that the longitudinal axis of the respective contact element is at a greater distance from the edge than the central longitudinal axis of the corresponding receiving chamber in which the corresponding connection terminal is arranged.

In an advantageous embodiment of the invention, the terminal elements are arranged in a plurality of terminal element rows, the terminal elements in each terminal element row being aligned uniformly in each case, and the terminal elements in adjacent terminal element rows being aligned differently in rows, and/or the terminal elements are arranged in a plurality of terminal element columns, the terminal elements in each terminal element column being aligned uniformly in each case, and the terminal elements in adjacent terminal element columns being aligned differently in columns. A corresponding design enables, in particular, a simple provision of terminal units with a plurality of terminal elements in each row. The terminal unit can also be provided with a simple structure and based on a small number of different components. Preferably, the terminal elements are evenly spaced.

Rows or columns in the aforementioned embodiments are straight rows or columns, so that a combination of rows and columns results in a matrix. The arrangements of contact elements, receiving chambers and terminal elements in rows or columns can in principle be realized independently of each other.

In an advantageous embodiment of the invention, the terminal unit has a common housing in which the plurality of terminal elements is arranged. The housing provides protection for the terminal unit, for example protection against contact, protection against soiling or the like, and also facilitates handling of the terminal unit. In particular, the contact elements can protrude from the housing for contacting the electrical contacts. The housing can define the edges of the terminal unit.

In an advantageous embodiment of the invention, the terminal unit has a common housing in which the plurality of terminal elements is arranged. The housing provides protection for the terminal unit, for example protection against contact, protection against soiling or the like, and also facilitates handling of the terminal unit. In particular, the contact elements can protrude from the housing for contacting the electrical contacts. The housing can define the edges of the terminal unit.

In an advantageous embodiment of the invention, the terminal elements are identical. The identical design of the terminal elements enables simple and cost-effective provision of the terminal unit, since only one type of terminal elements needs to be provided. Various of the previously described embodiments can be realized by a suitable alignment in the terminal unit.

The problem underlying the present invention is also solved by a unit comprising a printed circuit board and a terminal unit with the features of claim 11.

More specifically, the problem underlying the present invention is also solved by a unit comprising a printed circuit board having a plurality of electrical contacts, which are designed in particular as electrical contact holes or contact points, and a terminal unit which is connected to the electrical contacts of the printed circuit board for making contact with a plurality of electrical conductors, the terminal unit being configured according to any one of claims 1 to 10.

The advantages of the terminal unit according to the invention arise for the present unit when connecting the electrical contacts of the printed circuit board to the terminal unit.

The problem underlying the present invention is also solved by a contacting set with the features of claim 12.

More specifically, the problem underlying the present invention is also solved by a contacting set comprising a plurality of different terminal units for electrically contacting a plurality of electrical contacts, in particular electrical contact holes or contact points of a printed circuit board, with a plurality of electrical conductors, wherein at least one of the terminal units is configured according to any one of claims 1 to 10.

By providing the contacting set, a simple means is created for adapting the contacting with the electrical conductors to the respective requirements when using predetermined printed circuit boards with corresponding electrical contacts by selecting one or more suitable terminal units. It is not necessary to change the layout of the printed circuit board, as the adaptation can be made by selecting the appropriate terminal unit.

The problem underlying the present invention is additionally solved by a printed circuit board contacting set with the features of claim 13.

More specifically, the problem underlying the present invention is additionally solved by a printed circuit board contacting set comprising a printed circuit board and a plurality of different terminal units for electrically contacting a plurality of electrical contacts, in particular electrical contact holes or contact points, of the printed circuit board with a plurality of electrical conductors, wherein at least one of the terminal units is designed according to one of claims 1 to 10.

In contrast to the provision of the contacting set, the printed circuit board contacting set includes the printed circuit board in addition to the terminal units. This ensures that the printed circuit board and the terminal units are correctly matched and that the different terminal units can be used for the printed circuit board without further problems.

Further advantages, details and features of the invention are shown below in the examples of embodiments described. These show in detail:

FIG. 1: a simplified schematic representation of a terminal unit from the state of the art in top view, in which longitudinal axes of contact elements are arranged in accordance with central longitudinal axes of receiving chambers in which the respective connection terminals are arranged;

FIG. 2: a simplified, schematic representation of a terminal unit according to a first, preferred embodiment of the present invention in top view, having four terminal elements which are arranged in two rows, each having a contact element and a connecting terminal which is accommodated in a receiving chamber, a longitudinal axis of the contact element being arranged axially offset with respect to a central longitudinal axis of the receiving chamber in which the corresponding connecting terminal is arranged;

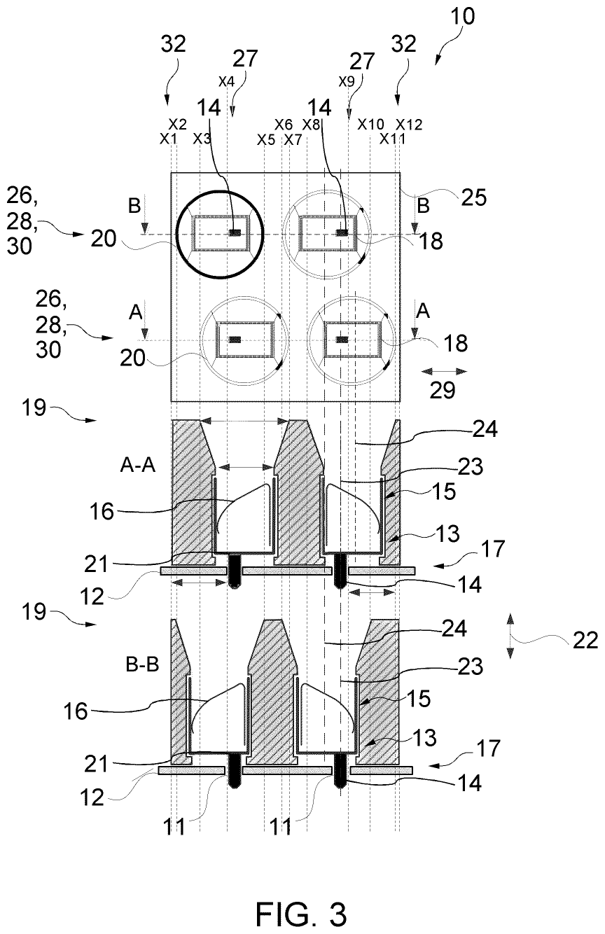

FIG. 3: a simplified, schematic representation of the terminal unit of FIG. 2 in a top view in accordance with FIG. 2 and two additional sectional views in the area of a first and second terminal element row;

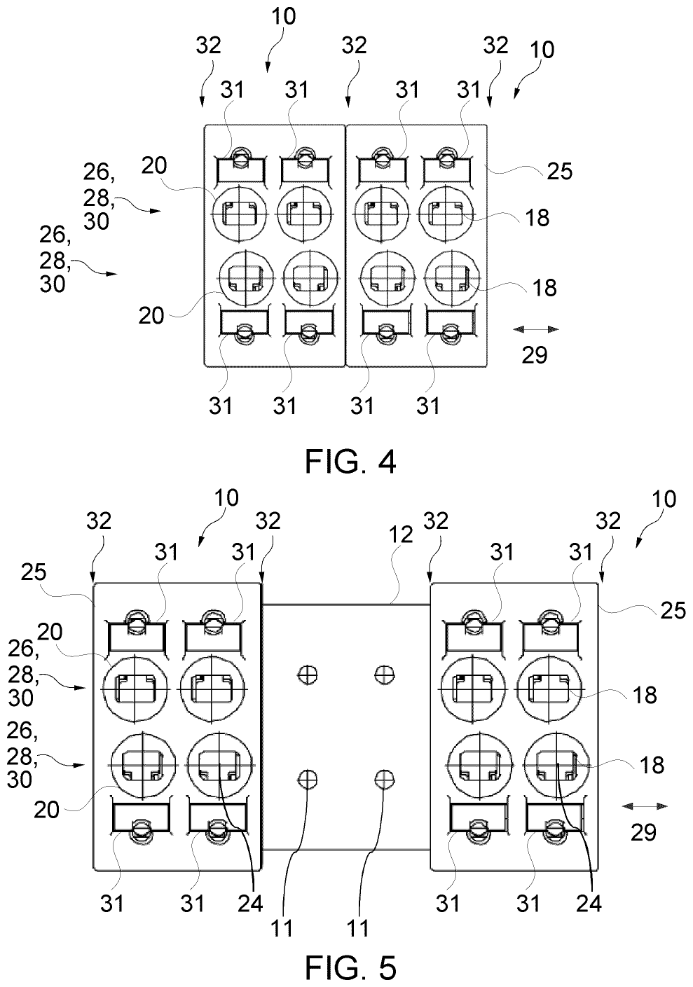

FIG. 4: a simplified, schematic representation of two terminal units according to a second embodiment of the present invention in top view, each with four terminal elements arranged in two rows and with actuating pushers;

FIG. 5: a simplified, schematic representation of two terminal units according to a third embodiment of the present invention in top view, each with four terminal units arranged in two rows and with actuating pushers, the terminal elements being positioned on a printed circuit board with electrical contacts;

FIG. 6: a schematic representation of a printed circuit board for electrical contacting with one or more terminal unit(s) according to a fourth embodiment;

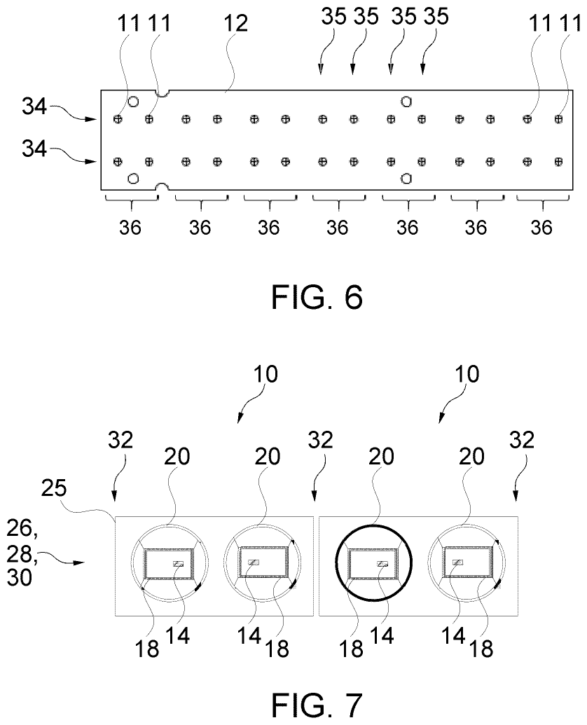

FIG. 7: a simplified, schematic representation of two terminal units according to a fifth embodiment, each with two terminal elements;

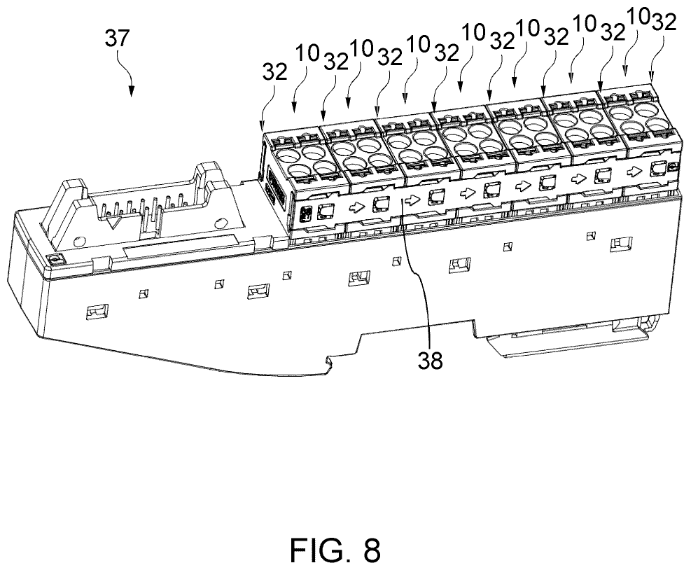

FIG. 8: a simplified, schematic representation of a plug with a plurality of terminal units, each with two terminal elements according to a sixth embodiment.

In the following description, identical reference numerals denote identical components or identical features, so that a description of a component in relation to one figure also applies to the other figures, thus avoiding a repetitive description. Furthermore, individual features described in connection with one embodiment can also be used separately in other embodiments.

FIGS. 2 and 3 show a terminal unit 10 according to a first, preferred embodiment of the present invention.

The terminal unit 10 is designed for electrical contacting of a plurality of electrical contacts 11, which are configured here as electrical contact holes of a printed circuit board 12, with a plurality of electrical conductors not shown.

The terminal unit 10 comprises a plurality of electrically conductive terminal elements 13, each of which has a contact element 14 for electrical connection to one of the contact holes 11 and a connection terminal 15 for contacting one of the electrical conductors. In this example, the contact elements 14 are designed as contact pins, which are inserted into the contact holes 11 of the printed circuit board 12 and soldered therein. The connection terminals 15 are designed as spring-loaded terminals with a clamping spring 16 for clamping the respective electrical conductor, as can be seen in the sectional views in FIG. 3. The contact pins 14 are arranged on an underside 17 of the terminal unit 10 and protrude from the underside 17 of the terminal unit 10 for contacting the contact holes 11. The spring-loaded terminals 15 are arranged in receiving chambers 18 for receiving the electrical conductors. The receiving chambers 18 have a rectangular cross-section and, towards an upper side 19 of the terminal unit 10, a funnel-shaped insertion orifice 20 for inserting the electrical conductors.

The terminal units 10 of the first embodiment also have actuating elements in the form of actuating pushers, although these are not explicitly shown in FIGS. 2 and 3. When actuated, the actuating pushers release the clamping of the electrical conductors by the clamping springs 16 in the spring-loaded terminal 15.

All spring-loaded terminals 15 each have a base region 21 at their ends opposite the insertion orifices 20. The contact pins 14 are attached to the base region 21 of the spring-loaded terminals 15 and extend in the longitudinal direction 22 thereof.

As can be seen in FIGS. 2 and 3, the terminal elements 13 are designed in such a way that a longitudinal axis 23 of the contact pin 14 is axially offset from a central longitudinal axis 24 of the receiving chamber 18 in which the corresponding spring-loaded terminal 15 is arranged.

The terminal elements 13 are made of an electrically conductive metal sheet and have an overall elongated shape. Accordingly, the terminal unit 10 is designed for contacting in the longitudinal direction 22. All terminal elements 13 of the terminal unit 10 are of identical design.

The terminal unit 10 has a common housing 25 in which the terminal elements 13 are arranged.

As can be further seen in FIGS. 2 and 3, the contact pins 14 extend on the underside 17 of the terminal unit 10 in two contact element rows 26 and two contact element columns 27, whereby the contact pins 14 are evenly spaced in each contact element row 26 and in each contact element column 27. The contact pins 14 are thus arranged in a 2×2 matrix.

Furthermore, the receiving chambers 18 are arranged in a plurality of receiving chamber rows 28, wherein the receiving chambers 18 are evenly spaced in each receiving chamber row 28.

As can be seen from FIGS. 2 and 3, the contact element rows 26 and the receiving chamber rows 28 are arranged offset with respect to their longitudinal extension 29 and in the direction of their longitudinal extension 29. As a result, distances D2 between the insertion orifices 20, as can be seen from FIG. 2 compared to FIG. 1, and thus also distances between the receiving chambers 18 and the electrical conductors inserted therein can be increased compared to the prior art.

The terminal elements 13 are also arranged in a plurality of terminal element rows 30, with the terminal elements 13 in each terminal element row 30 being evenly spaced and evenly aligned. When comparing the two terminal element rows 30 of the terminal unit 10, it can be seen that the terminal elements 13 of the two terminal element rows 30 are aligned in opposite directions. In detail, it can be seen from FIGS. 2 and 3 that the terminal elements 13 in the two terminal element rows 30 are arranged rotated by 180°.

Overall, this results in a configuration of the terminal unit 10 in which the terminal elements 13 closest to the respective edge 32 are arranged at opposite edges 32 of the terminal unit 10 in such a way that the longitudinal axis 23 of the respective contact element 14 is at a greater distance from the edge 32 than the central longitudinal axis 24 of the corresponding receiving chamber 18 in which the corresponding connection terminal 15 is arranged. In more detail, in FIG. 3, the terminal element 13 on the left in the terminal element row 30 with the section B-B is thus the terminal element 13 closest to the left edge 32. Accordingly, this terminal element 13 is arranged in such a way that the longitudinal axis 23 of its contact element 14 is at a greater distance from the left edge 32 than the central longitudinal axis 24 of the corresponding receiving chamber 18 in which the corresponding connection terminal 15 is arranged. This arrangement is maintained for all terminal elements 13 of the terminal element row 30 with the section B-B. The same applies to the right-hand edge 32 in FIG. 3. The terminal element 13 on the right in the terminal element row 30 with section A-A is closest to the right-hand edge 32. Accordingly, this terminal element 13 is arranged in such a way that the longitudinal axis 23 of its contact element 14 is at a greater distance from the right-hand edge 32 than the central longitudinal axis 24 of the corresponding receiving chamber 18 in which the corresponding connection terminal 15 is arranged. This arrangement is maintained for all terminal elements 13 of the terminal element row 30 with the section A-A.

As a result, a distance line X4 is maintained at the left edge 32 in FIG. 3 for all contact elements 14 of the terminal elements 13 of the two terminal element rows 30. Correspondingly, a distance line X9 is maintained at the right-hand edge 32 in FIG. 3 for all contact elements 14 of the terminal elements 13 of the two terminal element rows 30.

FIG. 4 shows two terminal units 10 according to a second embodiment of the present invention, each with four terminal elements 13 arranged in two terminal element rows 30.

The terminal units 10 of the second embodiment essentially correspond to the terminal units 10 of the second embodiment in their structure and in the arrangement and orientation of their terminal elements 13, so that reference is made to the detailed description of the terminal units 10 of the first embodiment with regard to the corresponding features.

The terminal units 10 of the second embodiment are shown in FIG. 4 with actuating elements 31 in the form of actuating pushers, which are arranged on the upper side 19 of the terminal units 10. When actuated, the actuating pushers 31 release the clamping of the electrical conductors by the clamping springs 16 in the spring-loaded terminals 15.

The above remarks with regard to the design of the terminal unit 10 of the first embodiment, in which the terminal elements 13 closest to the respective edge 32 are arranged at opposite edges 32 of the terminal unit 10 in such a way that the longitudinal axis 23 of the respective contact element 14 is at a greater distance from the edge 32 than the central longitudinal axis 24 of the corresponding receiving chamber 18 in which the corresponding connection terminal 15 is arranged, also apply to the terminal unit 10 of the second embodiment.

FIG. 5 shows two terminal units 10 according to a third embodiment of the present invention, each with four terminal elements 13 arranged in two terminal element rows 30.

The two terminal units 10 are positioned on a printed circuit board 12. The two terminal units 10 of the third embodiment have corresponding actuating pushers 31 in accordance with the terminal units 10 of the second embodiment.

The above remarks with regard to the design of the terminal unit 10 of the first embodiment, in which the terminal elements 13 closest to the respective edge 32 are arranged at opposite edges 32 of the terminal unit 10 in such a way that the longitudinal axis 23 of the respective contact element 14 is at a greater distance from the edge 32 than the central longitudinal axis 24 of the corresponding receiving chamber 18 in which the corresponding connection terminal 15 is arranged, also apply to the terminal unit 10 of the second embodiment.

FIG. 6 shows a printed circuit board 12 for electrical contacting with one or more terminal unit(s) 10 according to a fourth embodiment. The printed circuit board 12 comprises a plurality of contact holes 11, which are arranged in two rows of holes 34 and a plurality of hole columns 35. The contact pins 14 of the terminal unit(s) 10 are inserted into the contact holes 11.

As can be seen from FIG. 6, the contact holes 11 in each row of holes 34 are arranged in groups 36 of two contact holes 11 in each case, with the contact holes 11 of each group 36 having a smaller distance to one another than to contact holes 11 of a respective adjacent group 36. When contacting with a terminal unit 10, the contact pins 14 have a corresponding arrangement to that of the contact holes 11.

Alternatively, several similar terminal units 10 with, for example, four terminal elements 13 can be used for contacting. In this case, for example, the contact elements 14 can each have a greater distance from the edge 32 to an adjacent terminal unit 10 than a central longitudinal axis 33 of the receiving chamber 18 in which the corresponding connection terminal 15 is arranged, in accordance with the above description of the arrangement of the terminal elements 13 of the terminal unit 10 of the first embodiment.

FIG. 7 shows a common arrangement of two terminal units 10 according to a fifth embodiment. Each of the terminal units 10 comprises two terminal elements 13, which are arranged in a terminal element row 30. The contact pins 14 are also arranged in a contact element row 26, as are the receiving chambers 18, which are arranged in a receiving chamber row 28.

As can be seen from FIG. 7, the two terminal elements 13 of each terminal unit 10 are each arranged rotated by 180°, so that the contact pins 14 on both sides are at a greater distance from the edge 32 than a central longitudinal axis 24 of the corresponding receiving chamber 18 in which the corresponding terminal 15 is arranged. This results in a particularly large distance between the contact pins 14 of adjacent terminal units 10.

FIG. 8 shows an application of several terminal units 10 for a plug 37 The terminal units 10 contact a printed circuit board 12 arranged in the plug 37 and each comprise four terminal elements 13 arranged in a 2×2 matrix. In addition, the terminal units 10 are laterally surrounded by a belt 38 and are fixed together on the plug 37.

### LIST OF REFERENCES

10 Terminal unit
11 Electrical contact, electrical contact hole
12 Printed circuit board
13 Terminal element
14 Contact element, Contact pin
15 Connection terminal, spring-loaded terminals
16 Clamping spring
17 Underside
18 Receiving chamber
19 Upper side
20 Insertion orifice
21 Base region
22 Longitudinal direction
23 Longitudinal axis
24 Central longitudinal axis
25 Housing
26 Contact element row
27 Contact element column
28 Receiving chamber row
29 Longitudinal extension
30 Terminal element row
31 Actuating element, actuating pusher
32 Edge
34 Row of holes
35 Hole column
36 Group
37 Plug
38 Belt
D2 Distance
X4 Distance line
X9 Distance line
100 Terminal (State of the art)
102 Contact element (State of the art)
104 Receiving chamber (State of the art)
106 Insertion orifice (State of the art)
D1 Distance (State of the art)

1. A terminal unit (10) for making electrical contact with a plurality of electrical contacts (11) with a plurality of electrical conductors, with
a plurality of electrically conductive terminal elements (13), each having a contact element (14), for electrical connection to one of the plurality of electrical contacts (11) and a connecting terminal (15) for contacting one of the plurality of electrical conductors,
wherein the plurality of electrically conductive terminal elements (13) are arranged in such a way that the contact elements (14) are arranged on an underside (17) of the terminal unit (10),
wherein the connecting terminal (15) is arranged in a receiving chamber (18) for receiving the plurality of electrical conductors, wherein the receiving chamber (18) has an insertion orifice (20) towards an upper side (19) of the terminal unit (10) for inserting the plurality of electrical conductors,
wherein in several of the plurality of electrically conductive terminal elements (13), a longitudinal axis (23) of the contact element (14) is arranged axially offset with respect to a central longitudinal axis (24) of the receiving chamber (18) in which the corresponding connecting terminal (15) is arranged, and
wherein the plurality of electrically conductive terminal elements (13) are arranged at opposite edges (32) of the terminal unit (10) in such a way that the longitudinal axis (23) of the respective contact element (14) is at a greater distance from the opposite edge (32) than the central longitudinal axis (24) of the receiving chamber (18) in which the connecting terminal (15) is arranged.

2. The unit (10) according to claim 1, wherein
the connecting terminal (15) has a base region (21) at ends opposite insertion orifices (20), and
the contact elements (14) are attached to the base region (21) of the connecting terminal (15) and extend in a longitudinal direction (22) thereof.

3. The unit (10) according to claim 1, wherein
the connecting terminal (15) is spring-loaded with a clamping spring (16), which hold inserted electrical conductors in a clamping manner with spring force, the terminal unit (10) having actuating elements (31) to release the clamping of the electrical conductors by the clamping spring (16) when actuated.

4. The unit (10) according to claim 1, wherein
the contact elements (14) extend on an underside (17) of the terminal unit (10) in a plurality of contact element rows, the contact elements (14) being evenly spaced in each contact element row.

5. The unit (10) according to claim 1, wherein
the receiving chambers (18) are arranged in a plurality of receiving chamber rows (28), the receiving chambers (18) in each receiving chamber row (28) being evenly spaced.

6. The unit (10) according to claim 1, wherein
contact element rows (26) and receiving chamber rows (28) are arranged offset in parallel with respect to a longitudinal extension (29).

7. The unit (10) according to claim 1, wherein
the terminal elements (13) are arranged in a plurality of terminal element rows (30), the terminal elements (13) in each terminal element row (30) being evenly spaced and being evenly aligned.

8. The unit (10) according to claim 7, wherein
the terminal elements (13) are arranged in a plurality of terminal element rows (30), the terminal elements (13) in each terminal element row (30) being aligned uniformly in each case.

9. The unit (10) according to claim 1, wherein
the terminal unit (10) has a common housing (25) in which the plurality of terminal elements (13) is arranged.

10. The unit (10) according to claim 1, wherein
the plurality of terminal elements (13) are configured identically.

11. A unit comprising a printed circuit board (12) having a plurality of electrical contacts (11), and a terminal unit (10) which is connected to the electrical contacts (11) of the printed circuit board (12) for making contact with a plurality of electrical conductors, the terminal unit (10) comprising:
a plurality of electrically conductive terminal elements (13), each having a contact element (14),) for contacting one of the plurality of electrical conductors,
wherein the plurality of electrically conductive terminal elements (13) are arranged in such a way that the contact elements (14) are arranged on an underside (17) of the terminal unit (10),
wherein the connecting terminal (15) is arranged in a receiving chamber (18) for receiving the plurality of electrical conductors, wherein the receiving chamber (18) has an insertion orifice (20) towards an upper side (19) of the terminal unit (10) for inserting the plurality of electrical conductors,
wherein in several of the plurality of electrically conductive terminal elements (13), a longitudinal axis (23) of the contact element (14) is arranged axially offset with respect to a central longitudinal axis (24) of the receiving chamber (18) in which the corresponding connecting terminal (15) is arranged, and
wherein the plurality of electrically conductive terminal elements (13) are arranged at opposite edges (32) of the terminal unit (10) in such a way that the longitudinal axis (23) of the respective contact element (14) is at a greater distance from the opposite edge (32) than the central longitudinal axis (24) of the receiving chamber (18) in which the connecting terminal (15) is arranged.

12. (canceled)

13. A printed circuit board contacting set having a printed circuit board (12) which has a plurality of electrical contacts (11) and a plurality of different terminal units (10) for making electrical contact between the electrical contacts (11) of the printed circuit board (12) and a plurality of electrical conductors, at least one of the terminal units (10) comprising:
a plurality of electrically conductive terminal elements (13), each having a contact element (14),) for contacting one of the plurality of electrical conductors,
wherein the plurality of electrically conductive terminal elements (13) are arranged in such a way that the contact elements (14) are arranged on an underside (17) of the terminal unit (10),
wherein the connecting terminal (15) is arranged in a receiving chamber (18) for receiving the plurality of electrical conductors, wherein the receiving chamber (18) has an insertion orifice (20) towards an upper side (19) of the terminal unit (10) for inserting the plurality of electrical conductors,
wherein in several of the plurality of electrically conductive terminal elements (13), a longitudinal axis (23) of the contact element (14) is arranged axially offset with respect to a central longitudinal axis (24) of the receiving chamber (18) in which the corresponding connecting terminal (15) is arranged, and
wherein the plurality of electrically conductive terminal elements (13) are arranged at opposite edges (32) of the terminal unit (10) in such a way that the longitudinal axis (23) of the respective contact element (14) is at a greater distance from the opposite edge (32) than the central longitudinal axis (24) of the receiving chamber (18) in which the connecting terminal (15) is arranged.
